(19) United States
(12) Patent Application Publication
(10) Pub. No.: US 2015/0316185 A1
(43) Pub. Date: Nov. 5, 2015

(54) LOCKING CATCH AND LATCH FOR QUICK CONNECT HYDRAULIC COUPLER

(71) Applicant: Kevin Mullin, Pittsburgh, PA (US)

(72) Inventor: Kevin Mullin, Pittsburgh, PA (US)

(21) Appl. No.: 14/799,962

(22) Filed: Jul. 15, 2015

Related U.S. Application Data
(63) Continuation-in-part of application No. 14/181,764, filed on Feb. 17, 2014, now abandoned.
(60) Provisional application No. 61/789,033, filed on Mar. 15, 2013.

(51) Int. Cl. F16L 21/08

(52) U.S. Cl. CPC F16L 21/08

(57) ABSTRACT

A double locking mechanism for male and female fluid coupling members that can lock the moveable sleeve on the female member in the open position to facilitate coupling with the male member, or in the closed position to prevent male member from disconnecting from female member. A catch is integrated with the nonmoveable portion of the female coupler and a latch such as a slot and offset is integrally formed in the female member's movable sleeve. Alternatively, the latch can attached or be integrally with, and extend from, the movable sleeve in the direction of the female coupler. The movable sleeve is retracted and rotated such that the latch engages the catch to lock the sleeve in an open position. When the male member is fully engaged with the female member, the movable sleeve is rotated so that the latch engages the catch to lock the sleeve in a closed position.

### CROSS-REFERENCE TO RELATED APPLICATIONS

This application is a Continuation-in-Part Application that claims the benefit of U.S. application Ser. No. 14/181,764, filed Feb. 17, 2014, which, in turn, claims the benefit of U.S. Provisional Application Ser. No. 61/789,033, titled LOCKING CATCH AND LATCH FOR QUICK CONNECT HYDRAULIC COUPLER, filed Mar. 15, 2013, which is incorporated by reference herein.

### BACKGROUND OF THE INVENTION

The present invention relates to quick connect hydraulic couplers. These hydraulic couplers are used in many industries for connecting hydraulic fluid lines. Many are used in the transportation industry to connect trailers to their tractors or hydraulic equipment in the field. The quick connect hydraulic coupler products currently available are very useful in joining hydraulic lines together. There are, however, a number of problems associated with their use. For example, there are many times that there is pressure in the lines from the hydraulic fluid which causes difficulty in connecting the lines. Also, the design of the female coupler makes the coupling task very difficult, especially in cold or wet weather. In most couplers, to allow the male coupler to enter the female coupler, the outer sleeve on the female coupler must be pulled back all the way to allow the ball bearings to slide outwardly so that the male coupler can fully enter. The springs in the sleeve exert an outward pressure that keeps the sleeve in a locked position. These springs are very strong in order to maintain the sleeve on the female coupler in the closed position. Thus, pulling the sleeve against the springs is very difficult. Making this task more difficult is that one needs one hand to pull the sleeve in the opposite direction from the mating coupler. Because of the location of the hydraulic lines, it is often times very difficult for the operator to hold the coupling flange backwards while attempting to align the male fitting into the coupler. Additionally, the grip on the fitting is difficult if the fitting is wet or oily and/or if there is residual pressure in the line. This often necessitates an additional set of hands.

Once the male fitting is fully engaged with the female, the sleeve needs to be released to allow the ball bearings to ride over the ‘head’ of the male fitting, and so that the sleeve can fully move back in place, thereby locking the two lines together. If the sleeve is not released before the person pushing the two lines together stops applying force, then the male will slip out.

Another flaw with the female coupler is that it is difficult to clean. Over time debris invades the inside of the female coupler. Rust, dirt, fluid and other substances tend to get under the sleeve and around the ball bearings. The smallest obstruction in and around any of the moving parts prevents the female coupler from working properly. Thus, cleaning the female coupler is more difficult than it should be. The operator must pull the sleeve all the way back into the “open” position. Once this operation is done, a tool can be used to clean out any dirt or obstructions. To accomplish this operation, one must use one hand to pull the sleeve back and hold it there while it is being cleaned. Even a person with great hand strength eventually loses grip and tires quickly.

Once the lines are successfully combined and locked, the hydraulic fluid or air is free to cycle through the coupling. However, while pressure from the fluid or air is cycling through, or has been cycling through and the machines turned off, it takes very little for the lines to accidentally disconnect. The female sleeve is typically only in its locked position and kept that way by the springs in the female coupling. There is nothing else, including any kind of pressure, that maintains the coupling in a locked or closed position. If the female sleeve is bumped in any way that slides it back, even a small amount, the lines will disconnect. Most conventional couplers have a locking ball in both the male and female ends. This typically prevents fluid/air from being released. However, even with this, it can be an unnecessary hassle and, at times, can be dangerous to the equipment and the operator.

### DESCRIPTION OF THE INVENTION

The present invention overcomes the problems described above by using a novel double locking means mounted to the movable sleeve on the female coupler. On the nonmoveable portion of the coupler is a catch mounted at the terminus of female sleeve's movement from the receiving end coupler. In a preferred embodiment of the invention, the double locking means comprises a latch configured as a slot and offset that is integrally formed into the female's movable sleeve, together with a catch that is attached to the female coupling member. The double locking means is positioned on the sleeve and female coupling member so that the catch can fully insert to the slot and engage the offset of the slot as the sleeve is rotated and moved to its fully retracted position. When the male fitting is engagedly positioned into the female, the sleeve is rotated to disengage the catch from the offset and out of the slot to permit the sleeve to fully encompass the mating portion of the male fitting. The sleeve can be then optionally rotated so that the catch engages a rest located in the side of the sleeve facing the female coupling member and on either side of the slot opening. When so located, the sleeve is prevented from axially moving away from engaged couplings, and, thereby, preventing a disconnection of the two members. Other double locking latch and catch embodiments associated with the sleeve can also be used.

Accordingly, the invention provides novel means that can lock the sleeve open and also lock the sleeve closed. When the sleeve is locked closed, the only way to open it is to turn the sleeve out of engagement. If the sleeve is bumped by any obstacle, it will not open and accidentally disconnect. This is because it needs to be manually rotated in the unlocking direction. Once rotated, an operator can pull back on the sleeve to either release the male coupler or prepare it to accept the male coupler. This has the potential for dramatically reducing accidental disconnects in all uses of quick connect hydraulic fluid and air couplers.

Placing the female couple in the locked open state and keeping it there is now simple and hands free. Once the sleeve is pulled all the way back, which allows the ball bearings to slide out, the user simply turns the sleeve about to engage the catch. The sleeve will stay in the locked open position. With the female sleeve in the locked open position, it facilitates simpler cleaning and maintenance of female coupler. Without having to hold the sleeve in the retracted position, an operator can use both hands to work all the small areas.

A primary benefit of the double locking sleeve is that it simplifies and makes it easier to join the quick connect hydraulic/air male and female couplers. There is no longer a need for another set of hands to hold the sleeve back. The operator can use both hands to align the male and female couplers and push them together. A better understanding of the invention's embodiments can be gleaned from the drawings of the preferred embodiments below.

### DRAWINGS

FIG. 1 is a perspective view of the male portion of a coupling of the present invention;

FIG. 2 is a perspective view of the female coupling with its latch and catch in its normal position;

FIG. 3 is a perspective view of the female coupling of the present invention showing the sleeve in its retracted position with the double L latch engaging the catch to facilitate connection;

FIG. 3A is a side view of the female coupling of FIG. 3;

FIG. 4 is an elevation of the male and female engaged with the latch engaging the bottom side of the catch to prevent the sleeve from moving out of engagement position;

FIG. 5 is an elevation of another embodiment of the invention with a catch outside a latch formed by a slot and offset; and

FIG. 6 is an elevation of the embodiment of the invention of FIG. 5, with the catch inside the slot.

### DETAILED DESCRIPTION OF THE INVENTION

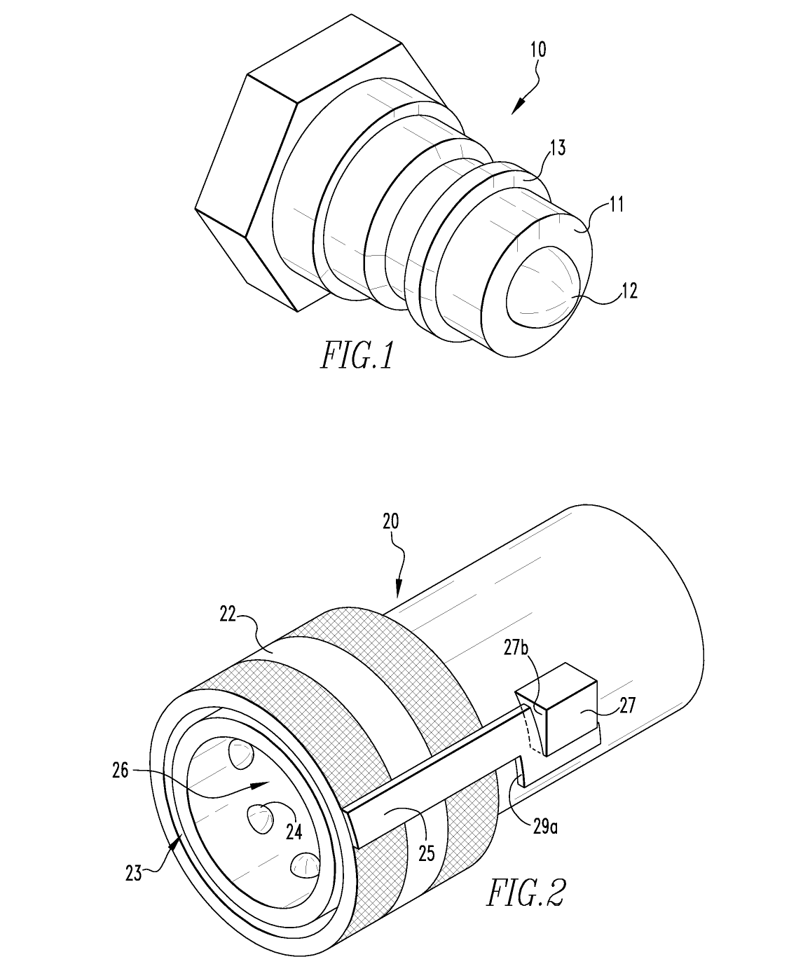

Referring to FIG. 1 a perspective view of a male coupler 10 is shown. Coupler 10 comprises insertion end 11 having a recessed ball valve 12 which prevents back flow of the hydraulic fluid (air or fluid). An engaging flange 13 provides a means for internal engagement with the bearing in the female coupling 20.

Referring to FIGS. 2, 3, 3A, and 4, sleeve 22 includes latch 25. Latch 25 comprises a “double L” configuration with leg 29 thereof having engagement surfaces 29a and 29b. Engagement surfaces 29a and 29b provide for the engagement with respective surfaces 27a and 27b of catch 27. Catch 27 is preferably positioned on the outer surface of female coupling 20 at a location between surface 27b of catch 27 and sleeve 22 when the terminus of movement of sleeve 22 is reached as it is moved away from end 23 to a “closed” position. The distance between sleeve 22 and surface 27b is preferably at least equal to the width “a” of catch 27. Catch 27 can have a rounded or flat surface.

As shown in 2, 3, 3A, and 4, latch 25 can be formed separately and attached to the external surface of sleeve 22. In alternative embodiments, latch 25 can be formed integral with sleeve 22, such that latch 25 protrudes from the side of sleeve 22 facing female coupling 20. In this embodiment, sleeve 22 does not appear on the surface of sleeve 22 and does not interrupt any cross-hatching on the surface of sleeve 22 that assists in the gripping and rotation of sleeve 22.

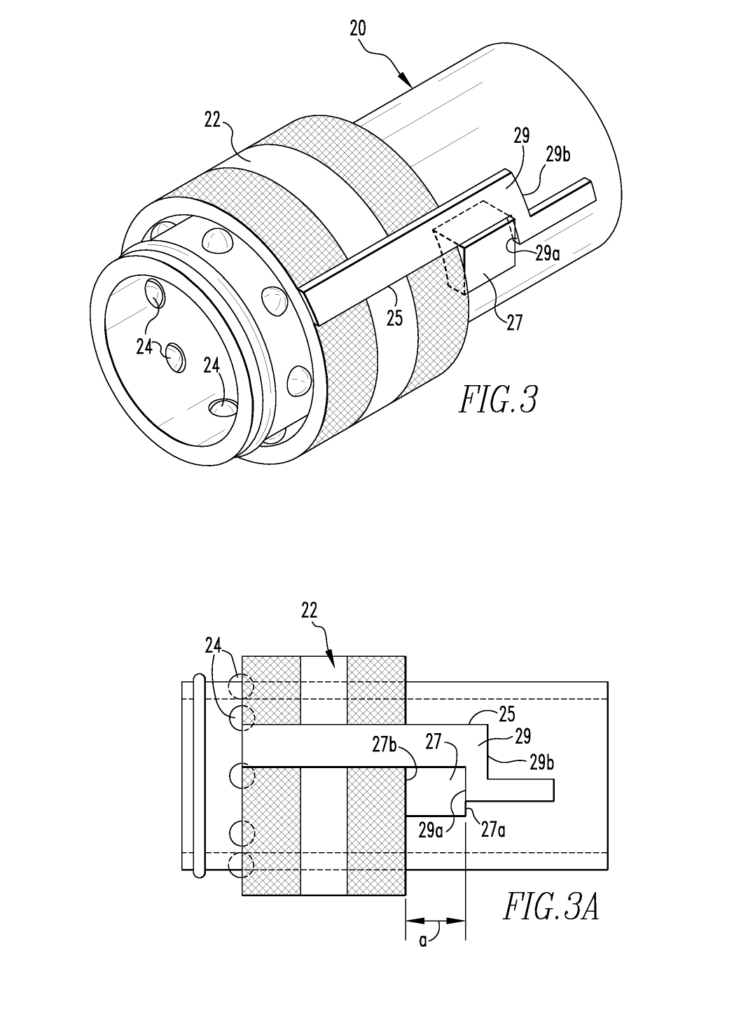

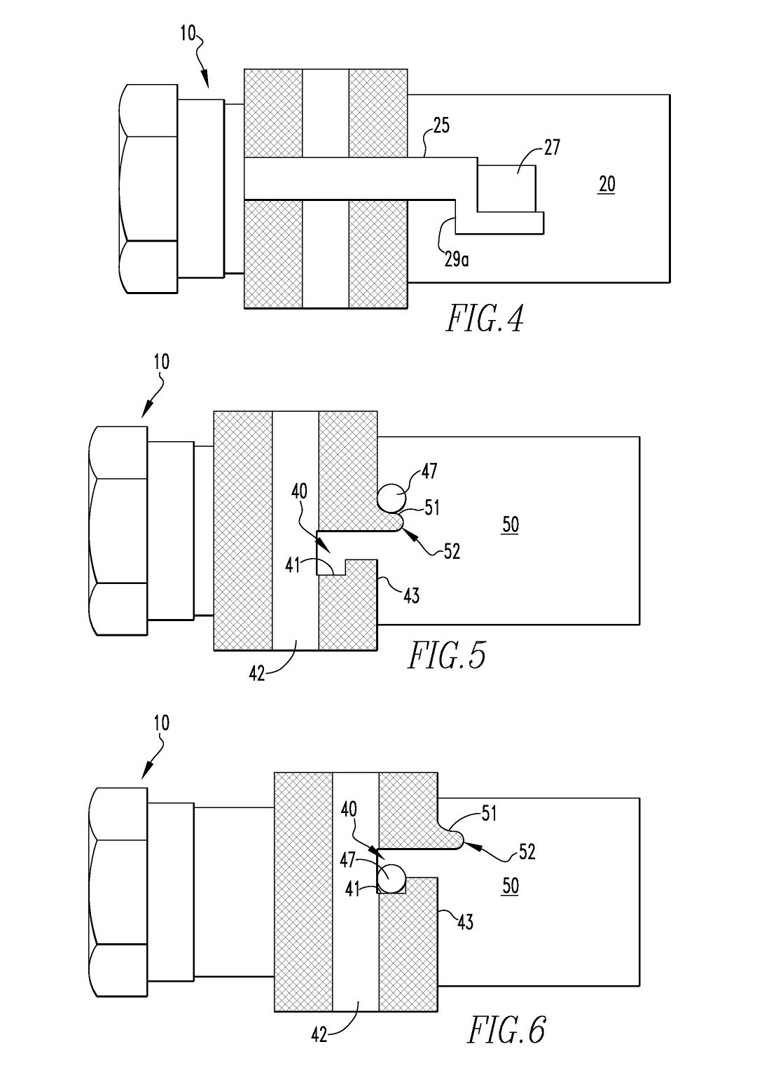

Referring to FIGS. 3 and 3A, sleeve 22 is shown fully retracted on female coupling. Surface 29a of leg 29 of latch 25 is designed to rest on outer edge 27a of catch 27. When sleeve 22 is retracted its full extent and edge 29a of leg 29 of latch 25 is engaging side 27a of the catch 27, the female coupling is fully open for cleaning and for insertion of male 10. It also permits the operator to insert male 10 into the female without force. Rotating sleeve 22 disengages the sleeve from catch 27 and permits the sleeve to move to full engagement with the male 10 by reason of its biasing spring. By rotating sleeve 22, the outer edge 29b of latch 25 can engage the inner edge 27b of catch 27, thereby preventing unintentional linear movement of the sleeve as depicted in FIG. 4. It is clear that design modifications can be made to both the latch and catch within the scope of the appended claims. The preferred embodiment provides an extremely effective and easily used safety feature.

The use of the catch 27 and latch 25, coupling of hydraulic fluid lines is greatly facilitated with a corresponding benefit that once coupled the catch and latch prevents lateral movement of the sleeve, thus preventing unintended disengagement of the coupling. In its retracted state, the coupling of the two ends is greatly facilitated.

Referring to FIG. 5, another embodiment of the invention is shown. In particular, using similar operational characteristics, latch 40, in one embodiment, comprises an “L” or “J” shaped cut or slot 41 through sleeve 42 on female member 50. Other cut shapes with an angled and offset end portion or portions, such as an “E” or inverted “T” can also be used. The slot, in operation, receives catch 47 when sleeve 42 is retracted to an “open” position for receiving male member 10.

More directly, latch 40 is formed as an axial slot 41 in sleeve 42, with the slot extending from the edge of sleeve 42 facing female member 50. The inner axial length of slot 41 is substantially equal to the length of axial movement and retraction of sleeve 42. The width of slot 41 is slightly larger than the width of the catch to be accommodated. A circumferential offset is cut at the base of slot to engage and lock catch 47 when the sleeve 42 is fully retracted for insertion of the male annular flange and also to engage and lock the catch 47 when the male annular flange is fully engaged with sleeve 42.

Catch 47 is positioned on the female coupling 50 immediately adjacent to and abutting the inner edge 43 of sleeve 42. Catch 47 can comprise a small pin which can be placed in a small opening and welded/brazed in place, or otherwise attached in a fixed manner, on the coupling 50. The geometric shape of catch 47 can vary. A plurality of catches 47 can be positioned around the circumference of female coupling as well as an equal number of latches 40 juxtaposed to a corresponding catch 47. In either embodiment, only slight rotation and a withdrawal of the sleeve from the opening will permit retention of the latch or latches in its associated catch. In addition, in a preferred embodiment, catch 47 interacts with a rest or notch 51 associated with sleeve 42 and that operates to stop catch 47 from moving out of a locked position when sleeve 42 is an open position as shown in FIG. 5. This is similar to the “closed” position of sleeve 22 shown in FIG. 2 of the alternative embodiment of the invention discussed above (with the double locking mechanism of slot and offset 41, catch 47, and rest 51 substituting for latch 25 and catch 27). Rest 51 can be formed as a protrusion 52 from sleeve 42, as shown in FIGS. 5 and 6. Alternatively, rest 51 can be cut into sleeve 42. Rest 51 can be formed integral with sleeve 42, or added to sleeve 42 after it is formed. For example, a strip of sleeve 42 could be cut and offset to form a protrusion 52 on the side of female member 50, with a corresponding cut or inset on the opposite side of sleeve 42 facing male 10. In addition, rest 51 can be formed or created on the upper or lower sides of the opening for slot 41, and the distance of rest 51 from the opening of slot 41 can vary. Further, two or more rests can be used.

Referring to FIG. 6, the embodiment of the invention shown in FIG. 5 is depicted where sleeve 42 has been rotated so that catch 47 is located fully within slot 41. This is the same retracted or “open” position described in connection with the embodiment of the present invention shown in FIGS. 3 and 3A. As shown in FIG. 6, the inner portion of slot 40 angles downward (the bottom leg of the “L” shape of the slot) to provide a locked position when catch 47 is fully with slot 41. Again, slot 41 can be formed other shapes—so long as an angled portion—or offset—is provided to interact with catch 47 to assist in locking sleeve 42 in an open position.

While presently preferred embodiments of the invention has been shown and described, the invention may be otherwise embodied within the scope of the appended claims.

What is claimed is:

1. A fluid coupling assembly having a male member and a female member, the female member having an annular receiving end for receiving the male member having an annular end with an annular flange, and the female member further comprising:
a receiving end including a plurality of annular bearings adapted to be engaged by the annular flange of the male member:
an annular sleeve slidably mounted on the exterior of the female member and having a biasing means biasing the annular flange to the receiving end of the female member;
a catch on the exterior of the female member juxtaposed to the sleeve when the sleeve is positioned in its normal, un-retracted position; and
a latch formed as an axial slot in the sleeve extending from the inner edge of the sleeve an axial length equal to the movement of the sleeve and having a circumferential offset at its base;
whereby the slot and offset operate to engage and lock the catch and sleeve when the sleeve is fully retracted for insertion of the male annular flange and the catch also operates to engage and lock the sleeve when the male annular flange is fully engaged with the sleeve.

2. A coupling assembly as set forth in claim 1, wherein the slot and offset is in the form of “J”.

3. A coupling assembly as set forth in claim 1, wherein the slot and offset is in the form of “L”.

4. A coupling assembly as set forth in claim 1, wherein the slot and offset is in the form of an inverted “T”.

5. A coupling assembly as set forth in claim 1, wherein the slot and offset is in the form of “E”.

6. A coupling assembly as set forth in claim 1, wherein the female member further comprises a rest on the inner edge of the sleeve to assist the catch in engaging and locking the sleeve when the male annular is fully engaged with the sleeve.

7. A coupling assembly as set forth in claim 6, wherein the rest is formed by a protrusion from the inner edge of the sleeve.

8. A coupling assembly as set forth in claim 6, wherein the rest is formed by a notch into the inner edge of the sleeve.

9. A coupling assembly as set forth in claim 6, the rest is located proximate to the slot.

10. A coupling assembly as set forth in claim 6, wherein two or more rests are on the inner edge of the sleeve.

11. A fluid coupling assembly having a male member and a female member, the female member having an annular receiving end for receiving the male member having annular end with an annular flange, the female member receiving end including a plurality of annular bearings adapted to be engaged by the annular flange of the male member, and the female member further comprising:
an annular sleeve slidably mounted on the exterior of the female member and having a biasing means biasing the flange to the receiving end of the female member;
a catch on the exterior of the female member juxtaposed and spaced away from the sleeve when the sleeve is positioned fully away from the receiving end; and
a latch mounted to the sleeve to engage and lock the catch when the sleeve is fully retracted for insertion of the male annular flange and also to engage and lock the catch when the male annular flange is fully engaged with the sleeve.

12. A fluid coupling assembly as set forth in claim 7, wherein the latch is in the form an inverted “L” and is adapted to engage the catch.

13. A fluid coupling assembly as set forth in claim 7, wherein the latch is the form of a “T” and is adapted to engage the catch.

14. A fluid coupling assembly as set forth in claim 7, wherein the catch comprises a post mounted adjacent the sleeve.
